(19) United States
(12) Patent Application Publication
(10) Pub. No.: US 2018/0174811 A1
(43) Pub. Date: Jun. 21, 2018

(54) MASS SPECTROMETRY DEVICE

(71) Applicant: Hitachi High-Technologies Corporation, Tokyo (JP)

(72) Inventors: Tsukasa SHISHIKA, Tokyo (JP); Akihito KANEKO, Tokyo (JP)

(21) Appl. No.: 15/840,171

(22) Filed: Dec. 13, 2017

(30) Foreign Application Priority Data
Dec. 16, 2016 (JP) 2016-243962

(51) Int. Cl. H01J 49/04; H01J 49/24

(52) U.S. Cl. CPC H01J 49/0468; H01J 49/0495; H01J 49/24; H01J 49/0409

(57) ABSTRACT

The mass spectrometry device includes: a sample container for containing a sample; a heater for heating the sample container; an ion source for ionizing the sample vaporized in the sample container by being heated by the heater; an introduction unit that includes a valve, and that introduces the vaporized sample in the sample container into the ion source; a mass spectrometry unit that includes a vacuum chamber, and to which ions generated in the ion source are introduced; a vacuometer for measuring a degree of vacuum of the vacuum chamber; and a controller that controls the valve to intermittently introduce the vaporized sample in the sample container into the ion source. The controller controls an open time of the valve according to the degree of vacuum of the vacuum chamber that varies as a result of the ions being intermittently introduced into the mass spectrometry unit.

### BACKGROUND OF THE INVENTION

### 1. Field of the Invention

The present invention relates to a mass spectrometry device, particularly to a small-sized, light mass spectrometry device.

### 2. Description of Related Art

Amass spectrometry device ionizes a sample of interest for analysis, separates the ions according to their mass using an electric field and a magnetic field, and detects the separated ions with a detector. There is an increasing need for quick, on-site analysis, and studies are conducted to reduce the size of a mass spectrometry device. To achieve a small-sized mass spectrometry device, it is important to reduce the size of the vacuum pump used by reducing the amount of the gas introduced into amass spectrometry unit where ions are separated according to their mass. In order to directly reduce the amount of introduced gas, gas is intermittently introduced into a mass spectrometry unit. JP-A-2013-37815 discloses such a mass spectrometry device.

In the technique disclosed in JP-A-2013-37815, a sample gas and ions are brought in by utilizing the difference between the atmospheric pressure, the degree of vacuum of an ion source, and a degree of vacuum of a vacuum chamber. Accordingly, the amount of generated ions will be different when maintenance is performed for the intervening valves and orifices. For example, in the case of a low-viscous flow with a relatively low degree of vacuum inside the valve, the flow rate of the vaporized gas passing through a constricted portion of the valve is substantially proportional to the fourth power of the channel diameter. Accordingly, for a given channel length, 10% variation in channel diameter results in as much as an about 50% change in the flow rate of the vaporized gas flowing into the ion source. Similarly, the amount of ions that flow into a mass spectrometry unit varies with variation occurring in orifice diameter.

However, the amount of gas introduced to a sample analyzing section for each analysis is very small even in a short time period, for example, a single analysis period of about 120 seconds, in which the conductance of the intervening valves and orifices can be regarded as being almost constant. It was found that this causes fluctuations of the gas flow rate under varying temperatures and pressures, and prevents a quantitative analysis.

### SUMMARY OF THE INVENTION

A primary object of the present invention is to relieve the conditions that cause fluctuations in a device during the measurement, and improve the repeatability of measurement results for improved measurement accuracy.

Amass spectrometry device of an aspect of the invention includes:

a sample container for containing a sample;

a first heater for heating the sample container;

an ion source for ionizing the sample vaporized in the sample container by being heated by the first heater;

an introduction unit that includes a valve, and that introduces the vaporized sample in the sample container into the ion source;

a mass spectrometry unit that includes a vacuum chamber, and to which ions generated in the ion source are introduced;

a vacuometer for measuring a degree of vacuum of the vacuum chamber; and

a controller that controls the valve to intermittently introduce the vaporized sample in the sample container into the ion source,

the controller controlling an open time of the valve according to the degree of vacuum of the vacuum chamber that varies as a result of the ions being intermittently introduced into the mass spectrometry unit.

Other objects, configurations, and advantages of the present invention will be more clearly understood from the descriptions of the embodiment below.

An advantage of the present invention is to relieve the conditions that cause fluctuations in a mass spectrometry device during the measurement, and improve the repeatability of measurement results for improved measurement accuracy.

### BRIEF DESCRIPTION OF THE DRAWINGS

FIG. 1 is a schematic diagram showing a mass spectrometry device.

FIG. 2 is a diagram representing changes in the degree of vacuum of a vacuum chamber with the valve open/close operation.

FIG. 3 is a diagram representing changes in the degree of vacuum of a vacuum chamber when a moisture-containing sample (methoxyphenamine aqueous solution) is heated.

FIG. 4 is a diagram representing changes in the degree of vacuum of a vacuum chamber when a moisture-free sample (noscapine) is heated.

FIG. 5 is a diagram showing a configuration of a heatable, air-operated valve.

FIG. 6 is a diagram representing the result after the changes in the degree of vacuum of the vacuum chamber were reduced by controlling the open time of a valve against a methoxyphenamine aqueous solution.

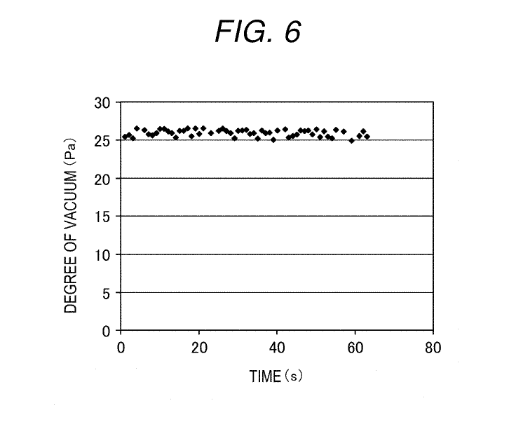

FIG. 7 shows a variation of the ion source.

### DESCRIPTION OF THE PREFERRED EMBODIMENTS

An embodiment of the invention is described below with reference to the accompanying drawings.

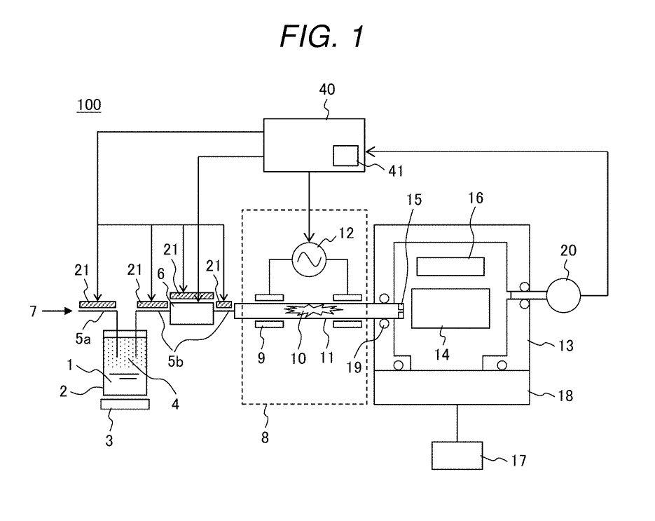

FIG. 1 shows a mass spectrometry device 100 according to an embodiment. A sample 1 of interest for analysis is placed in a sealed sample bin (sample container) 2. The sample 1 may have a solid form, for example, a powdery form, or may have a liquid form. Heating the sample bin 2 with a heater 3 vaporizes the sample, and generates vaporized gas 4. The sample bin 2 is connected to a tube 5a in a sealed state. The tube 5a is connected to a gas cylinder containing an inert gas (for example, nitrogen gas) of a predetermined pressure (for example, 1 atmosphere) . This creates a pressure difference from a vacuum chamber 13, and an inert gas 7 is introduced. The introduced gas may be the atmosphere, instead of the inert gas 7. It is, however, preferable to use the inert gas 7 because the inert gas 7 allows for an analysis under a controlled environment of pressure and gas components. A valve 6 is provided on the downstream side of the sample bin 2, and the degree of vacuum in the glass tube 11 is controlled with the open/close operation of the valve 6. The sample bin 2, the valve 6, and a glass tube 11 are connected to each other via a tube 5b. The tubes 5a and 5b, and the valve 6 introducing the vaporized gas 4 from the sample bin 2 to the glass tube 11 constitute an introduction unit . The valve 6 is left open only for several tens of milliseconds at one time, and this is repeated at, for example, 1 second intervals.

An ion source 8 is configured from the glass tube 11 for accepting the introduced vaporized gas 4, tubular electrodes 9 disposed at two locations of the glass tube 11, and a high-frequency power supply 12. The high-frequency power supply 12 applies a high frequency of several hundred kilohertz and several kilovolts to the tubular electrodes 9 to generate an electromagnetic field inside the glass tube 11, and creates a barrier discharge 10. Closing the valve 6 after it was left open for a certain time period from a closed state causes the vaporized gas 4 to flow into the glass tube 11, and momentarily lowers the degree of vacuum in the glass tube 11. The degree of vacuum in the glass tube 11 increases again as the vaporized gas 4 flows out into the vacuum chamber 13 . The barrier discharge 10 stably generates when the degree of vacuum in the glass tube 11 ranges from several hundred to several thousand pascals (Pa), and ionizes the vaporized gas 4 in the discharge region. Specifically, the vaporized gas 4 that has flown into the vacuum chamber 13 is ionized by the barrier discharge 10, and introduced into a mass separation unit 14. Here, the mass separation unit 14 needs to have a high degree of vacuum to improve the performance of mass spectrometry. In order to create a vacuum difference, an orifice 15 having a small diameter of 1 mm or less is provided between the ion source 8 and a mass spectrometry unit.

The mass spectrometry unit is configured from the mass separation unit 14 formed by four ion-trapping electrodes, an ion detector 16, and the vacuum chamber 13 surrounding these components . The ions generated in the ion source 8 pass through the orifice 15, and are incident on the mass separation unit 14. In the mass separation unit 14, the ions become accumulated in the space between the four ion-trapping electrodes by the confined electric field. By varying the amplitude or frequency of the auxiliary AC voltage superimposed on the ion-trapping electrodes, the ions are passed through the ion-trapping electrode slit situated in a direction orthogonal to the axial direction of the ion-trapping electrodes, according to their mass-to-charge ratio. With the ions entering the ion detector 16, the components of the vaporized gas 4 are determined. In an alternative process, only specific ions are kept in the ion-trapping region by an FNF (Filtered Noise Field) process, and decomposed into fragment ions by a CID (Collision Induced Dissociation) process. The fragment ions can then be introduced into the ion detector 16 for more accurate analysis of the components. The vacuum chamber 13 is evacuated with a primary vacuum pump 18, which may be a high-evacuation turbo-molecular pump. The downstream side of the primary vacuum pump 18 is vacuumed with a roughing vacuum pump 17, which may be a diaphragm pump having a relatively lower evacuation rate. Though not illustrated, the electrodes are connected to a high-voltage power supply, and the whole operation is controlled by a controller 40.

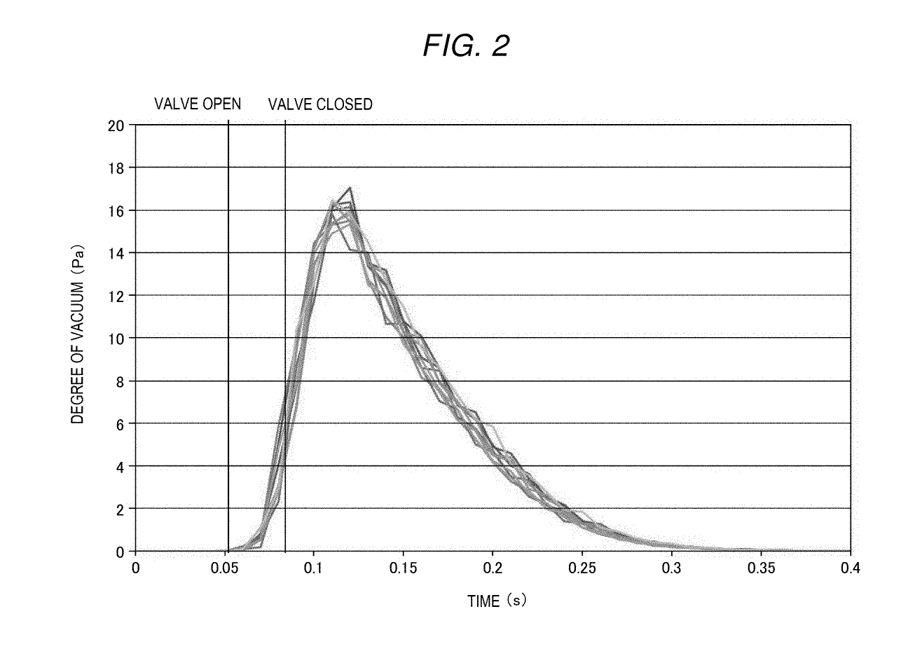

In the mass spectrometry device 100, size reduction and lightness are achieved by ionizing the vaporized gas 4 in pulses by the open/close operation of the valve 6 to reduce the amount of ions that generate at one time. FIG. 2 represents changes in the degree of vacuum of the vacuum chamber 13 over a time course when the valve 6 is opened and closed in the sequence close/open/close. In this example, the valve was left open for 30 ms, and changes in the degree of vacuum of the vacuum chamber 13 were repeatedly measured. The ion detector 16 determines the components of the vaporized gas for the ions as the ions are introduced into the vacuum chamber 13 by each valve operation. Because the amount of vaporized gas to be analyzed in a single analysis is very small, the analysis is performed over a period of, for example, 120 seconds in 1 second intervals before the components of the vaporized gas are finally specified. For the quantitative analysis of the vaporized gas components, the amount of vaporized gas introduced by the repeated valve operations needs to remain constant. In the actual mass spectrometry device, adjustments, including adjustments of introduced ion amounts, can be made by making the introduced pressure constant. Accordingly, analysis is possible when substantially the same change is repeated for the degree of vacuum of the vacuum chamber 13 over the course of an analysis (120 seconds; see FIG. 2).

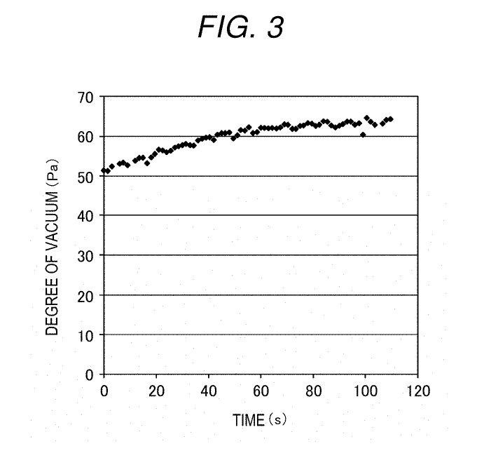

However, it was found that the sample temperature has large impact on the pressure of the introduced gas. When the sample contains moisture, a large expansion of water vapor occurs with temperature increase, and the amount of vaporized gas introduced into the vacuum chamber 13 decreases. FIG. 3 represents the measured degree of vacuum of the vacuum chamber 13 when a methoxyphenamine aqueous solution used as a sample was heated from 50° C. to 95° C. for the first 50 seconds, and maintained at 95° C. for the next 70 seconds. Because the degree of vacuum in the vacuum chamber varies in the manner shown in FIG. 2 in each introduction, FIG. 3 plots the degree of vacuum at the peak value of the waveform. The degree of vacuum shows a decrease from about 50 Pa to 65 Pa as the temperature increases.

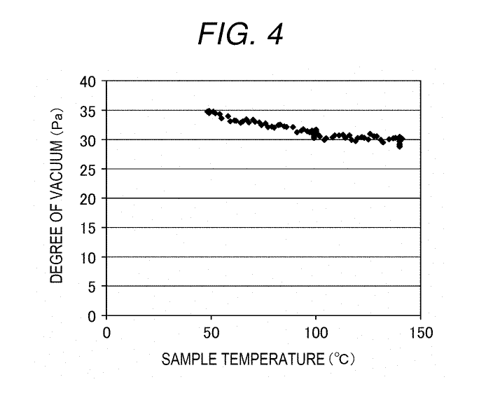

In the case of a sample containing no moisture, a phenomenon has been shown to occur in which the reachable pressure in the vacuum chamber 13 decreases (the degree of vacuum increases) with increase in sample temperature. FIG. 4 shows a relationship between sample temperature and vacuum chamber 13 when noscapine (powder) is heated. The degree of vacuum is about 30 Pa at a sample temperature of about 140° C., as opposed to 35 Pa at a sample temperature of 50° C.

In actual practice, analyzed samples are often mixtures of more than one substance, and the presence of substances having different boiling points results in the composition of the vaporized gas being changed by temperature changes. For quantitative analysis of a trace vaporized gas, it is accordingly required to maintain the sample temperature constant throughout the analysis. To this end, a heater 21 is provided for the tubes 5 and the valve 6 in the mass spectrometry device 100. The temperature of the heater 21 is set by the controller 40. By maintaining the temperature of the vaporized gas 4 constant throughout the analysis, it is possible to prevent the sample of the previous analysis from mixing into the current sample (carry-over), which may occur when the vaporized gas liquefies with decreasing temperatures, or when the sample deposits inside the tubes 5. Accordingly, the heater 21 is set to a temperature equal to or greater than the temperature set for the heater 3.

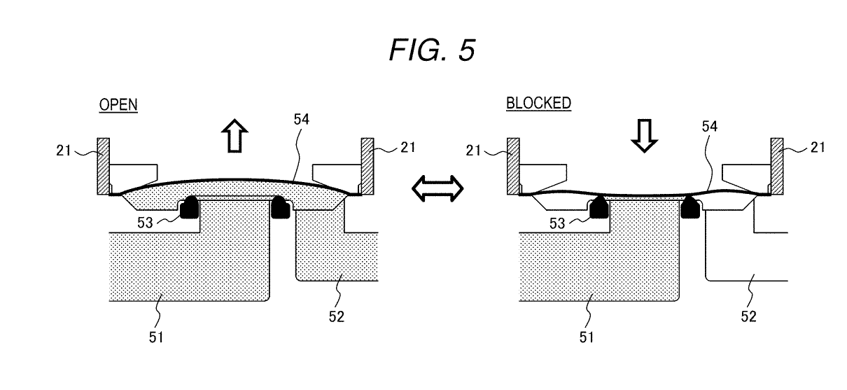

For low-volatile components, a sample may need to be heated to about 200° C. to 300° C. However, with a conventionally used solenoid valve, the operation becomes unstable when the valve-controlling winding portion reaches a temperature of about 105° C. or higher, and the valve becomes inoperable. To avoid this, an air-operated valve is used as the valve 6 in the embodiment. FIG. 5 shows a configuration of a heatable, air-operated valve. As illustrated in the figure, a diaphragm 54 is provided between a tube 51 and a tube 52. When open, the diaphragm 54 is convex up, and the tubes are conductive. When closed, the diaphragm 54 is convex down, and the diaphragm 54 and a sealing material 53 block the conduction of the gas. The state of the diaphragm 54 is changed by controlling air pressure. The air-operated valve does not use wires for control, and the operation does not become unstable even with high-temperature gas passing inside the valve. The heater 21, which is provided near the main body of the valve in the figure, may be embedded in the valve itself.

It has been confirmed that the degree of vacuum in the vacuum chamber 13 varies with time when a sample contains moisture, even when the sample is maintained at the same temperature. In the embodiment, the amount of vaporized gas introduced into the vacuum chamber 13 is controlled to improve accuracy. Specifically, a vacuometer 20 for measuring the degree of vacuum in the vacuum chamber 13 is provided, and the open time of the valve 6 is controlled according to the degree of vacuum of the vacuum chamber 13. As described above, the vaporized gas 4 is introduced in pulses, and as such the degree of vacuum of the vacuum chamber 13 shows large changes in a short time period. It is accordingly desirable that the vacuometer 20 is adapted to enable a high-speed measurement with a time lag of about 10 ms. In order to keep the vacuum chamber 13 air tight, the vacuometer 20 is connected to the vacuum chamber 13 via, for example, an O ring 19, and a joint.

The flow rate Q of the gas entering the vacuum chamber can be represented by the following mathematical formula (1).

Q≈C×(P₁−P₂)−C₂×(P₂−P₃) Formula (1)
C₁: Conductance of orifice 15
C₂: Conductance between vacuum chamber 13 and primary vacuum pump 18
P₁: Degree of vacuum on the upstream side of glass tube 11
P₂: Degree of vacuum of vacuum chamber 13
P₃: Degree of vacuum of primary vacuum pump 18

Typically, the parameters C₁ and C₂ remain the same throughout the analysis, and the parameters P₁, P₂, P₃ representing the degrees of vacuum are the same immediately before the valve 6 is opened. This is because the hole diameter of the sample introducing system, and the evacuation rate of the vacuum pump, which determine the conductance, do not change even when the sample solvent or sample temperature varies.

The pressure increase dP in the vacuum chamber 13 during the open time Δt of the valve 6 can be represented by the following mathematical formula (2).

dP=Q/V×Δt Formula (2)
V: Volume of vacuum chamber 13

It follows from this that the pressure value P of the vacuum chamber 13 is represented by the following mathematical formula (3).

P=∫dPdt=∫(Q/V×Δt)dt Formula (3)

That is, it can be seen that the degree of vacuum of the vacuum chamber 13 is dependent on the open time Δt of the valve 6. In the embodiment, the pressure P is monitored by the vacuometer 20, and Δt is controlled to make the P constant. Specifically, the pressure P may be controlled to make Δt smaller when the degree of vacuum (peak value of the waveform) of the vacuum chamber 13 is low, that is when the degree of vacuum at the peak of the waveform of the degree of vacuum is low. On the other hand, the pressure P may be controlled to make Δt larger when the degree of vacuum (peak value of the waveform) of the vacuum chamber 13 is high, that is when the degree of vacuum at the peak of the waveform of the degree of vacuum is high. In this way, the amount of introduced sample can be accurately controlled, and the measurement repeatability can be improved even when the sample is intermittently introduced.

The control described above is performed by the controller 40. The controller 40 has a memory 41 storing a device adjusting program. The controller 40 monitors the degree of vacuum of the vacuum chamber 13 according to the device adjusting program, and the open time of the valve 6 is controlled according to the degree of vacuum of the vacuum chamber 13 monitored by the controller 40. The device adjusting program is used to control evacuation of the vacuum pump, and the discharge voltage and discharge time of the high-frequency power supply 12, in addition to the temperature control of the heater 21.

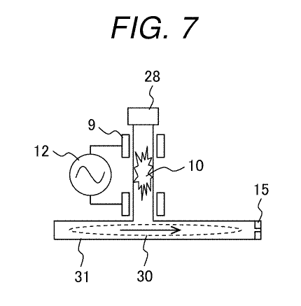

FIG. 7 shows a variation of the ion source 8. The ion source 8 may use a T-shaped glass tube 31, instead of the straight glass tube 11 shown in FIG. 1 . By creating the barrier discharge 10 in the vicinity of the T-shaped branched portion, the barrier discharge region can be distanced from the region 30 where the vaporized gas 4 flows . One end of the T-shaped glass tube 31 is sealed to create a vacuum with a sealing plug 28.

With a straight glass tube, the vaporized gas 4 passes through the barrier discharge region, and the vaporized gas 4 directly reacts with high energy ions and electrons, and produces large numbers of fragment ions. One way of avoiding this problem is to supply the vaporized gas 4 to the downstream side, away from the barrier discharge region, using capillaries routed inside the glass tube, so that the reaction of the vaporized gas 4 with high-energy ions and electrons can be avoided. However, this complicates the structure.

With the structure shown in FIG. 7, the high-energy ions and electrons generated in the barrier discharge region 10 become extinguished as they collide with the residual gas over a distance before reacting with the vaporized gas 4. The remaining ions are predominantly low-energy ions and electrons, which enable softer ionization than achieved by the electron-impact ionization method. The vaporized gas molecules are therefore less likely to break in the reaction with ions and electrons, and, with the parent ions existing as predominant species, the amount of generated fragment ions becomes smaller, and the ionization method can be suitably used for the detection of a drug.

The detailed descriptions of the embodiment above are given to help illustrate the present invention, and the invention is not necessarily limited to including all of the configurations described above.

What is claimed is:

1. A mass spectrometry device comprising:
a sample container for containing a sample;
a first heater for heating the sample container;
an ion source for ionizing the sample vaporized in the sample container by being heated by the first heater;
an introduction unit that includes a valve, and that introduces the vaporized sample in the sample container into the ion source;
a mass spectrometry unit that includes a vacuum chamber, and to which ions generated in the ion source are introduced;
a vacuometer for measuring a degree of vacuum of the vacuum chamber; and
a controller that controls the valve to intermittently introduce the vaporized sample in the sample container into the ion source,
the controller controlling an open time of the valve according to the degree of vacuum of the vacuum chamber that varies as a result of the ions being intermittently introduced into the mass spectrometry unit.

2. The mass spectrometry device according to claim 1,
wherein the ions generated in the ion source are introduced into the mass spectrometry unit according to a difference between the degree of vacuum of the ion source, and the degree of vacuum of the vacuum chamber, and
wherein the controller leaves the valve open for a shorter time period when there is a decrease in the peak value of a waveform of the degree of vacuum of the vacuum chamber that varies as a result of the ions being intermittently introduced into the mass spectrometry unit, and leaves the valve open for a longer time period when there is an increase in the peak value of a waveform of the degree of vacuum of the vacuum chamber that varies as a result of the ions being intermittently introduced into the mass spectrometry unit.

3. The mass spectrometry device according to claim 1, wherein the device includes a second heater for maintaining a temperature of the introduction unit.

4. The mass spectrometry device according to claim 3, wherein the second heater is set to a temperature equal to or greater than a temperature of the first heater.

5. The mass spectrometry device according to claim 4, wherein the valve is an air-operated valve.

6. The mass spectrometry device according to claim 5, wherein the introduction unit includes a first tube through which an inert gas or air is introduced into the sample container at a predetermined pressure, a second tube that connects the sample container and the valve to each other, and a third tube that connects the valve and the ion source to each other.

7. The mass spectrometry device according to claim 6,
wherein the mass spectrometry unit includes a mass separation unit and an ion detector inside the vacuum chamber, and
wherein ions introduced into the mass separation unit are separated by the mass separation unit according to mass-to-charge ratio, and brought into the ion detector to determine components of the vaporized sample.
